(19) United States
(12) Patent Application Publication
(10) Pub. No.: US 2018/0094096 A1
(43) Pub. Date: Apr. 5, 2018

(54) HIGH-TEMPERATURE-RESISTANT FOAMS HAVING HIGH FLAME RETARDANCY

(71) Applicants: Covestro Deutschland AG, Leverkusen (DE); BASF SE, Ludwigshafen (DE)

(72) Inventors: Florian HUPKA, Düsseldorf (DE); Torsten HAGEN, Essen (DE); Peter NORDMANN, Dormagen (DE); Josip GACA, Leverkusen (DE); Roland KRÄMER, Mannheim (DE); Sindhu MENON, Osnabrück (DE)

(21) Appl. No.: 15/551,763

(22) PCT Filed: Feb. 17, 2016
(86) PCT No.: PCT/EP2016/053381

§ 371 Date: Aug. 17, 2017

(30) Foreign Application Priority Data
Feb. 20, 2015 (EP) 15155918.4

(51) Int. Cl. C08G 18/76; C08G 18/58; C08G 18/48; C08J 9/02; C08J 9/06; C08J 9/12; C08J 9/14

(52) U.S. Cl. CPC C08G 18/7664; C08G 18/58; C08G 18/4845; C08G 18/4825; C08J 9/02; C08J 2375/00; C08J 9/125; C08J 9/141; C08J 9/146; C08J 2205/10; C08J 2207/06; C08J 9/06

(57) ABSTRACT

The invention relates to high-temperature-resistant foams having excellent flame retardancy, to the production thereof from organic polyisocyanates and polyepoxides, and to the use of said foams.

The present invention relates to high-temperature resistant and flame-retardant foams and the preparation thereof by reacting reaction mixtures of organic polyisocyanates and organic polyepoxides with the addition of blowing agents and catalysts to the final foamed state, which is no longer meltable (hereinafter referred to as “EPIC foam”), and to the use thereof.

In early studies, DE 3 713 771, U.S. Pat. No. 3,793,236, U.S. Pat. No. 4,129,695 and U.S. Pat. No. 3,242,108 describe the preparation of foams from polyisocyanates and polyepoxides. In part, like in U.S. Pat. No. 3,849,349 or DE 3 824 685, the addition of further H-active substances is described. This results in undesirably high concentrations of urethane groups, which reduce the advantages of the EPIC foam. The blowing agents known in polyurethane chemistry are listed as possible blowing agents, and CFCs are preferably used in the Examples. The more recent prior art describes the preferred preparation of such foams from reaction mixtures of organic polyisocyanates and organic polyepoxides via an intermediate containing partially trimerized isocyanurate groups (=intermediate), which is stabilized by means of stoppers. In this case, the high-temperature resistant foams are obtained by reacting reaction mixtures of organic polyisocyanates, organic polyepoxides, catalysts and stoppers to form a storage-stable higher viscosity intermediate (“pretrimerization”), and reacting this higher viscosity intermediate by the addition of blowing agents and a catalyst spontaneously accelerating the isocyanate/epoxide reaction into the final foamed end state, which is no longer meltable.

The preparation of storage-stable preliminarily trimerized intermediates with the addition of an inhibitor having an alkylating effect as a stopper is at first described in EP 0 331 996 and EP 0 272 563. The preparation of an EPIC foam from an intermediate admixed with sulfonic acid alkyl esters having an alkylating effect as stoppers is disclosed in DE 39 38 062 A1. It is described that any organic polyisocyanates may be employed as the isocyanate component, especially polyisocyanate mixtures of the diphenylmethane series. In addition to the 2,4′-isomers, one among several other polyisocyanate components mentioned as being preferred may contain other isomeric or homologous polyisocyanates of the diphenylmethane series, and from 10 up to 60% by weight of higher nuclear polyphenyl polymethylene polyisocyanates, based on the total mixture of polyisocyanates.

According to WO 2012/80185 A1 and WO 2012/150201 A1, the quality of the thus prepared foams can be critically improved if certain blowing agents are used for the preparation of the EPIC foams. According to the teaching from these documents, the preparation of the EPIC foam is also preferably effected through the reaction of the starting materials in the presence of a stabilizer acting as a stopper. The polyisocyanate component employed as being preferred is either mixtures of 2,4′-MDI with 4,4′-MDI and optionally from 0 to 20% by weight of 2,2′-MDI, based on the total mixture, or mixtures of these isomers with higher nuclear oligomeric MDI, the latter generally being present in the mixtures at from 10% by weight to 60% by weight, based on the total mixture of polyisocyanates. In the Examples, mixtures of isomeric monomer MDI types are used.

The foams containing reaction products of the EPIC reaction and having high temperature resistance as described in the prior art are already known for their good mechanical properties and their high temperature stability. They also already have a reduced flammability as compared to that of polyurethane foams. However, The production method going through the two-stage process is quite complicated. Finally, the mechanical properties and especially the fire behavior of the foams with and especially without the addition of flame retardants should be further improved.

Therefore, it has been the object of the present invention to provide high-temperature resistant foams containing EPIC structures and having very good mechanical properties, a low thermal conductivity and improved flame-retardant properties as compared to the prior art.

As set forth above, the recent prior art relating to the preparation of foams containing EPIC structures recommends to the skilled person a process about the intermediate production of the reaction resin of polyepoxide and polyisocyanate containing isocyanurate structures from the trimerization reaction using stabilizers (stoppers). The skilled person also sees from the prior art that polyisocyanate mixtures containing a predominant proportion of monomeric MDI isomers are preferably used. None of the prior art documents deals with the further improvement of the flame retardancy of EPIC foams.

Surprisingly, it has now been found that high-temperature resistant EPIC foams can be obtained by the combined selection of particular polyisocyanates, the blowing agent and by omitting the use of stabilizers acting as stoppers, wherein the flame retardancy of such foams is clearly superior to that of the EPIC foams prepared according to the prior art.

The invention relates to high-temperature resistant foams obtainable by reacting

a) at least one mixture of organic polyisocyanates, and
b) at least one organic compound having at least two epoxy groups
in an amount that corresponds to an equivalent ratio of isocyanate groups to epoxy groups of from 1.2:1 to 500:1,
c) optionally at least one catalyst accelerating the isocyanate/epoxide reaction,
e) optionally in the presence of auxiliary agents and additives,
f) chemical and/or physical blowing agents,
characterized in that
said mixture of organic polyisocyanates a) contains more than 50% by weight, preferably more than 60% by weight, based on the total amount of polyisocyanates, of polyphenyl polymethylene polyisocyanates having a functionality f>2,
and that said chemical and/or physical blowing agents f) include at least one carboxylic acid selected from formic acid and acetic acid, or that said blowing agent consists of water and optionally one or more compounds selected from the group containing hydrocarbons, fluorocarbons, and fluorohydrocarbons,
and that the reaction proceeds in the absence of a component d) acting as a stopper.

The component d) acting as a stopper (also referred to as stabilizers for the intermediate stage of the reaction resin) is so-called catalyst poisons for the catalysts c). In particular, they are those selected from the group consisting of organic sulfonic acid esters, methyl iodide, dimethyl sulfate, benzenesulfonic acid anhydride, benzenesulfonic acid chloride, benzenesulfonic acid, trimethylsilyl-trifluoromethane sulfonate, the reaction product of benzenesulfonic acid with epoxides, and mixtures thereof.

The invention further relates to a process for preparing the high-temperature resistant foams according to the invention by reacting

a) at least one mixture of organic polyisocyanates, and
b) at least one organic compound having at least two epoxy groups
in an amount that corresponds to an equivalent ratio of isocyanate groups to epoxy groups of from 1.2:1 to 500:1,
c) optionally at least one catalyst accelerating the isocyanate/epoxide reaction,
e) optionally in the presence of auxiliary agents and/or additives,
f) chemical and/or physical blowing agents,
characterized in that
said mixture of organic polyisocyanates a) contains more than 50% by weight, preferably more than 60% by weight, more preferably 64% by weight, based on the total amount of polyisocyanates, of polyphenyl polymethylene polyisocyanates having a functionality f>2,
and that said chemical and/or physical blowing agents f) include at least one carboxylic acid selected from formic acid and acetic acid, or that said blowing agent consists of water and optionally one or more compounds selected from the group containing hydrocarbons, fluorocarbons, and fluorohydrocarbons,
and that the reaction proceeds in the absence of a component d) acting as a stopper.

After said foaming to the foamed state, a subsequent temperature treatment may be performed at from 70 to 250° C. (“annealing”).

The invention further relates to use of the high-temperature resistant foams according to the invention, optionally after annealing, as a filling foam for hollow spaces, as a filling foam for electric insulation, as a core of sandwich constructions, for the preparation of construction materials for all kinds of interior and exterior applications, for the preparation of construction materials for vehicle, ship, airplane and rocket construction, for the preparation of airplane interior and exterior construction parts, for the preparation of all kinds of insulation materials, for the preparation of insulation plates, tube and container insulations, for the preparation of sound-absorbing materials, for use in engine compartments, for the preparation of grinding wheels, and for the preparation of high-temperature insulations and hardly flammable insulations.

The invention further relates to use of the foamable mixtures before the foaming to the high-temperature resistant foam according to the invention is complete for adhesively bonding substrates, for adhesively bonding steel, aluminum and copper plates, plastic sheets, and polybutylene terephthalate sheets.

The invention further relates to hollow spaces, electric insulations, cores of sandwich constructions, sandwich constructions, construction materials for all kinds of interior and exterior applications, construction materials for vehicle, ship, airplane and rocket construction, airplane interior and exterior construction parts, all kinds of insulation materials, insulation plates, tube and container insulations, sound-absorbing materials, damping and insulation materials in engine compartments, grinding wheels, high-temperature insulations, and hardly flammable insulations, characterized by containing or consisting of the high-temperature resistant foams according to the invention.

The invention further relates to bondings between substrates, e.g., steel, aluminum and copper plates, plastic sheets, e.g., polybutylene terephthalate sheets, characterized by containing or consisting of the high-temperature resistant foams according to the invention.

Within the meaning of this application, a “high-temperature resistant foam” means that the “maximum average rate of heat emission” (MARHE) value as measured according to DIN EN ISO 5660-1 with an external radiant intensity of 50 kW/m² is <100 and thus lower than the average value of conventional polyurethane and polyisocyanurate foams without a flame retardant.

Said mixture of organic polyisocyanates a) is polyisocyanate mixtures containing >50% by weight, preferably >55% by weight, more preferably >60% by weight and even more preferably ≧64% by weight, based on the total mixture a), of higher nuclear polyphenyl polymethylene polyisocyanates. The higher nuclear polyphenyl polymethylene polyisocyanates (hereinafter referred to as “oligomeric MDI”) are mixtures of higher nuclear homologues of diphenylmethylene diisocyanate having an NCO functionality f>2 and having the following structural formula: C₁₅H₁₀N₂O₂ [C₈H₅NO]ₙ, where n=integer >0, preferably n=1, 2, 3 and 4.

In one embodiment, the oligomeric MDI contains 15-45% by weight, preferably 20-45% by weight, of triphenyl dimethylene triisocyanate (C₁₅H₁₀N₂O₂ [C₈H₅NO], f=3), 5-30% by weight, preferably 5-25% by weight, of tetraphenyl trimethylene tetraisocyanate (C₁₅H₁₀N₂O₂ [C₈H₅NO]₂, f=4), and 0-15% by weight of pentaphenyl tetramethylene pentaisocyanate, based on the total weight of the homologues and isomers to be identified analytically by HPLC, the sum amounting to 100% by weight. Higher nuclear homologues (C₁₅H₁₀N₂O₂ [C₈H₅NO]ₘ, m=integer ≧4) may also be contained in the mixture of organic polyisocyanates a).

Further components of the polyisocyanate mixture may preferably be the monomeric polyisocyanates of diphenylmethane (hereinafter: “monomeric MDI”), which are the isomers 2,2′-diisocyanatodiphenylmethane (2,2′-MDI), 2,4′-diisocyanatodiphenylmethane (2,4′-MDI) and 4,4′-diisocyanatodiphenylmethane (4,4′-MDI). Preferably, the monomeric MDI contains 0-5% 2,2-MDI, 0-55% 2,4-MDI and 40-100% 4,4-MDI, based on the total amount of monomeric MDI.

Preferably, the polyisocyanate mixture a) consists of a mixture of oligomeric MDIs and monomeric MDI (hereinafter referred to as “polymeric MDI”). Polymeric MDI is known and is often referred to as polyphenyl polymethylene polyisocyanate. The proportion of oligomeric MDI in polymeric MDI is >50% by weight, preferably >55% by weight, more preferably >60% by weight, and even more preferably ≧64% by weight.

A preferred polyisocyanate mixture a) has an NCO functionality f of 2.3 to 4, preferably 2.5 to 3.8, more preferably 2.7 to 3.5.

If no other polyisocyanates are present in addition to MDI types, an also preferred mixture of polyisocyanates a) consisting of a mixture of oligomeric MDIs and monomeric MDI has an NCO content of from 28 to 33.6% by weight, preferably from 29 to 32% by weight, and more preferably from 29.5 to 31.5% by weight. For example, the desired composition of such a mixture of polyisocyanates may be obtained by the phosgenation of aniline-formaldehyde condensates (GB 874 430 and GB 848 671), fractionating distillation and back mixing the distillation products.

In a preferred embodiment, the polyisocyanate component a) contains only aromatic polyisocyanates.

In one embodiment, the polyisocyanate component a) may further contain any organic polyisocyanates of the kind per se known from polyurethane chemistry. For example, aliphatic, cycloaliphatic, araliphatic, aromatic and heterocyclic polyisocyanates are suitable, as described, for example, by W. Siefken in Justus Liebigs Annalen der Chemie, 562, pages 75 to 136, for example, those of formula

Q(NCO)ₙ,

in which
n=2-4, preferably 2,
   and
Q represents an aliphatic hydrocarbyl radical with 2-18, preferably 6-10, carbon atoms, an aromatic hydrocarbyl radical with 6-15, preferably 6-13, carbon atoms, or an araliphatic hydrocarbyl radical with 8-15, preferably 8-13, carbon atoms, for example, ethylene diisocyanate, 1,4-tetramethylene diisocyanate, 1,6-hexamethylene diisocyanate, 1,12-dodecane diisocyanate, cyclobutane-1,3 diisocyanate, cyclohexane-1,3 and -1,4 diisocyanate, and any mixtures of these isomers. 1-Isocyanato-3,3,5-trimethyl-5-isocyanatomethylcyclohexane (DE Auslegeschrift 1 202 785, U.S. Pat. No. 3,401,190), 2,4- and 2,6-hexahydrotoluene diisocyanate, and any mixtures of these isomers, hexahydro-1,3- and/or -1,4-phenylene diisocyanate, perhydro-2,4′- and/or -4,4′-diphenylmethane diisocyanate, 1,3- and 1,4-phenylene diisocyanate, 2,4- and 2,6-toluene diisocyanate, and any mixtures of these isomers, diphenylmethane-2,4 and/or -4,4′ diisocyanate, naphthylene-1,5 diisocyanate.

Further, there may be used according to the invention, for example: m- and p-isocyanatophenylsulfonyl isocyanates (U.S. Pat. No. 3,454,606), perchlorinated arylpolyisocyanates (U.S. Pat. No. 3,277,138), polyisocyanates having carbodiimide groups (U.S. Pat. No. 3,152,162), norbornane dilsocyanates (U.S. Pat. No. 3,492,330), polyisocyanates having allophanate groups (GB 994 890), polyisocyanates having isocyanurate groups (U.S. Pat. No. 3,001,973), polyisocyanates having urethane groups (U.S. Pat. Nos. 3,394,164 and 3,644,457), acylated polyisocyanates having urea groups (DE-PS 1 230 778), polyisocyanates having biuret groups, (U.S. Pat. Nos. 3,124,605, 3,201,372 and 3,124,605), polyisocyanates prepared by telomerization reactions (U.S. Pat. No. 3,654,106), polyisocyanates having ester groups (U.S. Pat. No. 3,567,763), reaction products of the above mentioned isocyanates with acetals (DE-PS 1 072 385) and polyisocyanates containing polymeric fatty acid esters (U.S. Pat. No. 3,455,883). It is also possible to employ the distillation residues having isocyanate groups as obtained in technical isocyanate production, optionally dissolved in one or more of the above mentioned polyisocyanates. Further, it is possible to use any mixtures of the above mentioned polyisocyanates. Usually preferred are the technically readily accessible polyisocyanates, e.g., 2,4- and 2,6-toluene diisocyanate, and any mixtures of these isomers (“TDI”), and polyisocyanates having carbodiimide groups, urethane groups, allophanate groups, isocyanurate groups, urea groups or biuret groups (“modified polyisocyanates”), especially those modified polyisocyanates that are derived from 2,4- and/or 2,6-toluene diisocyanate or from 4,4′- and/or 2,4′-diphenylmethane diisocyanate.

Component b), which contains epoxy groups, is any aliphatic, cycloaliphatic, aromatic and/or heterocyclic compounds having at least two epoxy groups. The preferred epoxides that are suitable as component b) have 2 to 4, preferably 2, epoxy groups per molecule, and an epoxy equivalent weight of from 90 to 500 g/eq, preferably from 140 to 220 g/eq.

More preferably, component b), which contains epoxy groups, is any aromatic compound having at least two epoxy groups.

Suitable polyepoxides include, for example, polyglycidyl ethers of polyvalent phenols, for example, of pyrocatechol, resorcinol, hydroquinone, 4,4′-dihydroxy-diphenylpropane (bisphenol A), of 4,4′-dihydroxy-3,3′-dimethyldiphenylmethane, of 4,4′-dihydroxydiphenylmethane (bisphenol F), 4,4′-dihydroxydiphenylcyclohexane, of 4,4′-dihydroxy-3,3′-dimethyldiphenylpropane, of 4,4′-dihydroxydiphenyl, from 4,4′-dihydroxydiphenylsulfone (bisphenol S), of tris(4-hydroxyphenyl)methane, the chlorination and bromination products of the above mentioned diphenols, of novolacs (i.e., from reaction products of mono- or polyvalent phenols and/or cresols with aldehydes, especially formaldehyde, in the presence of acidic catalysts at an equivalent ratio of less than 1:1), of diphenols obtained by the esterification of 2 mole of the sodium salt of an aromatic oxycarboxylic acid with one mole of a dihaloalkane or dihalodialkyl ester (cf. British Patent 1 017 612) or of polyphenols obtained by the condensation of phenols and long-chained haloparaffins containing at least two halogen atoms (cf. GB-PS 1 024 288). Further, there may be mentioned: Polyepoxy compounds based on aromatic amines and epichlorohydrin, e.g., N-di(2,3-epoxypropyl)aniline, N,N′-dimethyl-N,N′-diepoxypropyl-4,4′-diaminodiphenylmethane, N,N-diepoxypropyl-4-aminophenyl glycidyl ether (cf. GB-PS 772 830 and 816 923).

In addition, there may be used: glycidyl esters of polyvalent aromatic, aliphatic and cycloaliphatic carboxylic acids, for example, phthalic acid diglycidyl ester, isophthalic acid diglycidyl ester, terephthalic acid diglycidyl ester, adipic acid diglycidyl ester, and glycidyl esters of reaction products of 1 mole of an aromatic or cycloaliphatic dicarboxylic acid anhydride and 1/2 mole of a diol, or 1/n mole of a polyol with n hydroxy groups, or hexahydrophthalic acid diglycidyl ester, which may optionally be substituted with methyl groups.

Glycidyl ethers of polyvalent alcohols, for example, of 1,4-butanediol (Araldite® DY-D, Huntsman), 1,4-butenediol, glycerol, trimethylolpropane (Araldite® DY-T/CH, Huntsman), pentaerythritol and polyethylene glycol, may also be used. Of further interest are triglycidyl isocyanurate, N,N′-diepoxypropyloxyamide, polyglycidyl thioether of polyvalent thiols, such as from bismercaptomethyl-benzene, diglycidyltrimethylenetrisulfone, polyglycidyl ether based on hydantoins.

Finally, epoxidation products of polyunsaturated compounds, such as vegetable oils and their conversion products, may also be employed. Epoxidation products of di- and polyolefins, such as butadiene, vinylcyclohexane, 1,5-cyclooctadiene, 1,5,9-cyclododecatriene, polymers and mixed polymers that still contain epoxidizable double bonds, e.g., based on polybutadiene, polyisoprene, butadiene-styrene mixed polymers, divinylbenzene, dicyclopentadiene, unsaturated polyesters, further epoxidation products of olefins that are accessible by Diels-Alder addition and are subsequently converted to polyepoxides by epoxidation with a per compound, or from compounds that contain two cyclopentene or cyclohexene rings linked through bridging atoms or bridge head atom groups, may also be used.

In addition, polymers of unsaturated monoepoxides may also be employed, for example, of methacrylic acid glycidyl ester or allyl glycidyl ether.

Preferably, the following polyepoxy compounds of mixtures thereof are used as component b) according to the invention:

Polyglycidyl ethers of polyvalent phenols, especially of bisphenol A (Araldit® GY250, Huntsman; Ruetapox® 0162, Bakelite AG; Epikote® Resin 162, Hexion Specialty Chemicals GmbH; Eurepox 710, Brenntag GmbH), and Araldit® GY250, Huntsman, or bisphenol F (4,4′-dihydroxydiphenylmethane, Araldit® GY281, Huntsman), polyepoxy compounds based on aromatic amines, especially bis(N-epoxypropyl)aniline, N,N′-dimethyl-N,N′-diepoxypropyl-4,4′-diaminodiphenylmethane and N,N-diepoxypropyl-4-aminophenylglycidylether; polyglycidyl ester of cycloaliphatic dicarboxylic acids, especially hexahydrophthalic acid diglycidyl ester and polyepoxides from the conversion product of n mol of hexahydrophthalic acid anhydride and 1 mole of a polyol with n hydroxy groups (n=integer of 2-6), especially 3 mol of hexahydrophthalic anhydride, and one mole of 1,1,1-trimethylolpropane; 3,4-epoxycyclohexylmethane-3,4-epoxycyclohexane carboxylate.

Polyglycidyl ethers of bisphenol A and bisphenol F as well as of novolacs are more particularly preferred.

The use of polyglycidyl ethers of bisphenol F is even more particularly preferred.

Liquid polyepoxides or low viscosity diepoxides, such as bis(N-epoxypropyl)aniline or vinylcyclohexane diepoxide, may further reduce the viscosity of already liquid polyepoxides in particular cases, or convert solid polyepoxides to liquid mixtures.

Component b) is employed in an amount that corresponds to an equivalent ratio of isocyanate groups to epoxy groups of from 1.2:1 to 500:1, preferably from 3:1 to 65:1, especially from 3:1 to 30:1, more preferably from 3:1 to 15:1.

In particular, any mono- or polyfunctional organic amines with tertiary amino groups may be employed as catalysts c).

Suitable amines of the kind mentioned generally have a molecular weight of up to 353 g/mol, preferably from 101 to 185 g/mol. Preferred are those tertiary amines that are liquid at the reaction temperature of the first reaction stage. Typical examples of suitable amines include triethylamine, tri-n-butylamine, dimethylcyclohexylamine, N,N,N′,N′-tetramethylethylenediamine, N,N-dimethylbenzylamine, triethylenediamine or dimethyloctylamine, N-methylmorpholine and bis(N,N-dimethylaminoethyl)ether, of which N,N-dimethylbenzylamine is preferred. Also suitable are, for example, pentamethyl-diethylene triamine, N-methyl-N′-dimethylaminoethylpiperazine, N,N-diethylethanolamine and silamorpholine. Preferably suitable are, in particular, dimethylbenzylamine, methyldibenzylamine, boron trichloride tert. amine adducts, and N-[3-(dimethylamino)propyl]formamide.

The suitable amines also include those that have a blowing effect in addition to the catalyst effect. In this case, the catalyst component c) also acts as a blowing agent at the same time.

Suitable amine catalysts may also contain functional groups that can react with isocyanate. Examples of employable catalysts that can be incorporated include bisdimethylaminopropylurea, bis(N,N-dimethylaminoethoxyethyl)carbamate, di-methylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethyl-aminopropyl-N,N-dimethylpropane-1,3-diamine, dimethyl-2-(2-aminoethoxy-ethanol) and (1,3-bis(dimethylamino)-propane-2-ol), N,N-bis(3-dimethylamino-propyl)-N-isopropanolamine, bis(dimethylaminopropyl)-2-hydroxyethylamine, N,N,N-trimethyl-N-(3-aminopropyl)bis(aminoethyl ether), 3-dimethylamino-isopropyl-diisopropanolamine, or mixtures thereof.

In one embodiment, the catalysts (c) are employed in an amount of from 0 to 2%, preferably from ≧0 to <2%, more preferably from ≧0 to <1.0%, by weight, based on the total weight of components (a) and (b). In a possible embodiment, no catalyst c) is added.

According to the invention, the blowing agent component f) includes at least one carboxylic acid selected from formic acid and acetic acid, or consists of water and optionally one or more compounds selected from the group containing hydrocarbons, fluorocarbons, and fluorohydrocarbons.

In particular, pentane, butane and/or hexane may be used as hydrocarbons, and 1,1,1,3,3-pentafluoropropane (HFC-245fa) may be used, in particular, as a fluorohydrocarbon.

In addition to said at least one carboxylic acid selected from formic acid and acetic acid, water and/or phospholine oxide may be used as chemical blowing agents. Hydrocarbons, such as pentane, butane, hexane, but also halogenated hydrocarbons, especially fluorocarbons or fluorohydrocarbons, for example, may be employed as physical blowing agents.

In a preferred embodiment, formic acid and fluorocarbons and/or fluorohydrocarbons, especially 1,1,1,3,3-pentafluoropropane (HFC-245fa), are employed as a blowing agent.

In a particularly preferred embodiment, formic acid is the sole blowing agent.

In another particularly preferred embodiment, the blowing agent consists of a mixture of at least 60% by weight formic acid and at most 40% by weight water, preferably of at least 80% by weight formic acid and at most 20% by weight water.

Preferred auxiliary agents and additives e) include the known foam stabilizers of the polyethersiloxane type, mold-release agents, e.g., polyamide waxes and/or stearic acid derivatives, and/or natural waxes, e.g., carnauba wax.

As said auxiliary agents and additives (e), there may be employed, for example, multifunctional compounds containing hydroxy or amino groups e1), which include e1-i) compounds having at least 2, especially from 2 to 8, and preferably from 2 to 3, alcoholic hydroxy groups and a molecular weight of from 62 to 8000 g/mol. Such compounds are per se known as structural components of polyurethane, and include low molecular weight chain extenders and polyols with number average molecular weights of more than 200 g/mol. Examples of chain extenders include simple polyhydric alcohols, such as ethylene glycol, hexanediol-1,6, glycerol or trimethylolpropane, examples of polyols include polyols having dimethylsiloxane moieties, for example, bis(dimethylhydroxymethylsilyl) ether; polyhydroxy compounds having ester groups, such as castor oil or polyhydroxy polyester, as accessible by the polycondensation of superfluous amounts of simple polyvalent alcohols of the kind just mentioned in an exemplary way with, preferably dibasic, carboxylic acids or anhydrides thereof, such as adipic acid, phthalic acid, or phthalic anhydride, polyhydroxy polyethers as accessible by an addition reaction of alkylene oxides, such as propylene oxide and/or ethylene oxide, with suitable starter molecules, such as water, the simple alcohols just mentioned above, or also amines having at least two aminic NH linkages, or polycarbonate polyols, which may be obtained, for example, from polyhydric alcohols and carbonates or phosgene.

In addition, the compounds e1) may also be e1-ii) compounds with at least two isocyanate-reactive hydrogen atoms, of which at least one belongs to a primary or secondary amino group. These include polyetheramines and compounds with molecular weights of less than 500 g/mol and two amino groups. Polyetheramines are known from polyurethane chemistry and can be obtained by terminal amination of polyether polyols. These preferably have molecular weights of from 500 to 8000 g/mol. The preferably used compounds with two amino groups and having molecular weights of smaller than 500 g/mol more preferably have a molecular weight of 58 to 300 g/mol, especially from 100 to 200 g/mol. These compounds preferably have two primary amino groups as said isocyanate-reactive groups. In a particularly preferred embodiment, the primary amino groups are linked to aromatic hydrocarbons, preferably to an aromatic six-ring, especially in meta- or para-position. In particular, diethylenetoluenediamine (DETDA), especially DETDA 80, is employed as said compounds e1-ii). Diethylenetoluenediamine is commercially available, for example, from Lonza or Albemarle.

If compounds with two amino groups and molecular weights of less than 500 g/mol are employed, it is preferably done in amounts of from 0.1 to 5, more preferably from 0.5 to 2% by weight, based on the total weight of compounds (a) and (b).

If any, the auxiliary agents and additives e1) are included in a maximum amount that corresponds to an NCO/OH equivalent ratio of at least 2:1, preferably at least 7:1, and especially at least 10:1, based on the isocyanate groups of component a) and the hydroxy groups and/or amino groups of component e1). At any rate, the amount of component a) must be such that the equivalent ratio of isocyanate groups of component a) to the sum of the epoxy groups of component b), hydroxy groups and/or amino groups of component e1) and the hydroxy groups that may be present in component b) is at least 1.2:1, preferably from 3:1 to 65:1, especially from 3:1 to 30:1, more preferably from 3:1 to 15:1.

The ratio of the weight of all compounds containing hydroxy and/or amino groups from component e1), preferably of polyols and polyetheramines, to the weight of epoxy component b) is preferably smaller than 30:70, preferably it is at most 28:72, more preferably at most 25:75, and even more preferably from 0-20:80-100.

The EPIC foam according to the invention preferably contains urethane groups and/or urea groups derived from the reaction of the polyisocyanate a) with component (e) at a small weight proportion. The content of urethane groups and/or urea groups resulting from the reaction of polyisocyanate a) with the hydroxy and/or amino groups from component e) is preferably below 6% by weight, preferably below 5% by weight, more preferably below 4% by weight, and even more preferably below 3% by weight, based on the total weight of the components.

In a particularly preferred embodiment, the EPIC foam has a content of urethane groups and/or urea groups resulting from the reaction of the polyisocyanate a) with the hydroxy and/or amino groups from component e) that is ≧0.01 to ≦1% by weight, preferably ≧0.01 to <0.8% by weight, based on the total weight of the components.

In one embodiment, the EPIC foam does not contain any urethane groups and/or urea groups resulting from the reaction of the polyisocyanate a) with component e).

Preferably, the reaction mixture contains less than 28% by weight, more preferably less than 25% by weight, of compounds containing hydroxy groups and/or amino groups of component e1), based on the total weight of components b) and e1), and the EPIC foam contains less than 6% by weight, preferably less than 5% by weight, even more preferably ≧0.01 to ≦1% by weight, especially preferably ≧0.01 to <0.8% by weight, based on the total weight of the components, of urethane and/or urea groups derived from the reaction of polyisocyanate a) with component e), based on the total weight of the foam.

More preferably, the reaction mixture contains less than 28% by weight, preferably less than 25% by weight, of polyols and/or polyether amines, based on the total weight of components b) and polyols and/or polyetheramines, and the EPIC foam contains less than 6% by weight, preferably less than 5% by weight, even more preferably ≧0.01 to ≦1% by weight, especially preferably ≧0.01 to <0.8% by weight, based on the total weight of the components, of urethane and/or urea groups derived from the reaction of polyisocyanate a) with component e), based on the total weight of the foam.

Further auxiliary agents and additives e) that may optionally be included are e2) polymerizable olefinically unsaturated monomers, which may be employed in amounts of up to 100% by weight, preferably up to 50% by weight, especially up to 30% by weight, based on the total weight of components a) and b).

Typical examples of additives e2) include olefinically unsaturated monomers having no hydrogen atoms that are reactive towards NCO groups, such as diisobutylene, styrene, C₁-C₄-alkylstyrenes, such as α-methylstyrene, α-butylstyrene, vinyl chloride, vinyl acetate, maleic imide derivatives, such as bis(4-maleinimidophenyl)methane, acrylic acid C₁-C₈-alkyl esters, such as acrylic acid methyl ester, acrylic acid butyl ester, or acrylic acid octyl ester, the corresponding methacrylic acid esters, acrylonitrile, or diallyl phthalate. Any mixtures of such olefinically unsaturated monomers may also be employed. Preferably, styrene and/or (meth)acrylic acid C₁-C₄-alkyl ester is used, provided that the additives e2) are employed at all.

If additives e2) are included, the inclusion of classical polymerization initiators, such as benzoyl peroxide, is possible, but generally not required.

The inclusion of auxiliary agents and additives e1) or e2) is generally not required. Incidentally, the additives mentioned by way of example under e1) are preferred over the compounds mentioned by way of example under e2). In principle, it is also possible to include both kinds of auxiliary agents and additives at the same time. However, to optimize the mechanical data of the EPIC foams, the addition of a low proportion of auxiliary agents and additives e2) or e3) may be advantageous, but wherein too large a proportion may in turn have a negative influence.

The further auxiliary agents and additives e) are preferably included only in such a maximum amount that the NCO/OH equivalent ratio is 2:1, preferably at least 7:1, and more preferably at least 10:1, based on the isocyanate groups of component a) and the hydroxy groups and/or amino groups of component e).

Further auxiliary agents and additives e) that may optionally be included are, for example, e3) fillers, such as quartz flour, chalk, microdol, alumina, silicon carbide, graphite or corundum; pigments such as titanium dioxide, iron oxide or organic pigments, such as phthalocyanine pigments; plasticizers, such as dioctyl phthalate, tributyl or triphenyl phosphate; compatibilizers that can be incorporated, such as methacrylic acid, β-hydroxypropyl ester, maleic acid and fumaric acid esters; substances improving flame retardancy, such as red phosphorus or magnesium oxide; soluble dyes or reinforcing materials, such as glass fibers or glass tissues. Also suitable are carbon fibers or carbon fiber tissues, and other organic polymer fibers, such as aramide fibers or LC polymer fibers (LC=“Liquid Crystal”). Further, metallic fillers may be considered as fillers, such as aluminum, copper, iron and/or steel. In particular, the metallic fillers are employed in a granular form and/or in powder form.

Further auxiliary agents and additives e) that may optionally be included are, for example, e4) olefinically unsaturated monomers with hydrogen atoms that are reactive towards NCO groups, such as hydroxyethyl methacrylate, hydroxypropyl methacrylate, and aminoethyl methacrylate.

The auxiliary agents and additives e) may be either incorporated in the starting materials a) and b) before the process according to the invention is performed, or admixed with them later.

For performing the process according to the invention, the starting materials a) and b) can be mixed with one another. Then, optionally further auxiliary agents and additives e), the catalyst c), said at least one carboxylic acid selected from formic acid and acetic acid and/or said water, and optionally the further blowing agents f) are added to the reaction mixture, all is thoroughly mixed, and the foamable mixture is cast into an open or closed mold.

When a multicomponent mixing head as known from polyurethane processing is used, the process is characterized by a high flexibility. By varying the mixing ratio of components a) and b), different foam qualities can be prepared with identical starting materials. In addition, different components a) and different components b) may also be supplied directly to the mixing head at different ratios. The auxiliary agents and additives e), the catalyst c), at least one carboxylic acid selected from formic acid and acetic acid and/or the water, and optionally further blowing agents f) may be supplied to the mixing head separately or as a batch. It is also possible to meter the auxiliary agents and additives e) together with the catalyst c), and to separately meter the blowing agents f). Foams with different bulk density ranges can be prepared by varying the amount of blowing agent.

Preferably, the mixing of the components is effected in one stage (so-called “one-shot” method). At any rate, the reaction should be performed without the step of preliminary trimerization. The preparation process can be performed continuously or discontinuously.

Depending on the components employed, the blowing process generally starts after a waiting time of 5 s to 6 min and is usually completed after 2-15 min. The foams are fine-celled and uniform. In one embodiment, they have foam densities of 25-80 kg/m³.

In order to achieve optimum properties, it is advantageous to perform a subsequent temperature treatment (“annealing”) after the foaming to the final foamed state.

In one embodiment, a subsequent temperature treatment at from 70 to 250° C., preferably from 120 to 250° C., more preferably from 180 to 220° C., is performed after the foaming to the final foamed state.

In another embodiment, which is also preferred, the foams are not annealed.

When a closed mold is used for preparing the foams according to the invention (mold foaming), it may be advantageous to overfill the mold in order to achieve optimum properties. “Overfilling” means that an amount of foamable mixture is filled in that would occupy a larger volume than the inner volume of the mold amounts to in an open mold after the foaming is complete.

The invention includes those embodiments that result from a combination of the embodiments mentioned in the description, especially of the embodiments mentioned as being preferred and particularly (or more) preferred.

In an exemplary embodiment of the process according to the invention:

a) a mixture of polyisocyanates containing more than 60% by weight polyphenyl polymethylene polyisocyanates with f>2 and the structural formula C₁₅H₁₀N₂O₂ [C₈H₅NO]ₙ, where n=integer >0, and
b) a polyglycidyl ether of multivalent phenols selected from the group consisting of the polyglycidyl ethers of bisphenol A, bisphenol F or of novolac,
in an amount that corresponds to an equivalent ratio of isocyanate groups to epoxy groups of from 3:1 to 15:1,
c) a catalyst accelerating the isocyanate/epoxide reaction, selected from the group consisting of dimethylbenzylamine, methyldibenzylamine, boron trichloride tert. amine adducts, and N-[3-(dimethylamino)propyl]formamide,
e) optionally in the presence of further auxiliary agents and additives, but which are included only in such a maximum amount that the NCO/OH equivalent ratio is more than 7:1, based on the isocyanate groups of component a) and the hydroxy groups and/or amino groups of component e),
f) formic acid or formic acid and hydrocarbons as blowing agents,
are reacted together in a one-shot process in the absence of a component acting as a stopper to form an EPIC foam.

The use of a polyglycidyl ether of bisphenol F in this embodiment is particularly preferred.

In another exemplary embodiment of the process according to the invention:

a) a mixture of polyisocyanates containing more than 60% by weight polyphenyl polymethylene polyisocyanates with f>2 and the structural formula C₁₅H₁₀N₂O₂ [C₈H₅NO]ₙ, where n=integer >0, and
b) a polyglycidyl ether of multivalent phenols selected from the group consisting of the polyglycidyl ethers of bisphenol A, bisphenol F or of novolac,
in an amount that corresponds to an equivalent ratio of isocyanate groups to epoxy groups of from 3:1 to 15:1,
c) a catalyst accelerating the isocyanate/epoxide reaction, selected from the group consisting of dimethylbenzylamine, methyldibenzylamine, boron trichloride tert. amine adducts, and N-[3-(dimethylamino)propyl]formamide,
e) optionally in the presence of further auxiliary agents and additives, but which are included only in such a maximum amount that the NCO/OH equivalent ratio is more than 7:1, based on the isocyanate groups of component a) and the hydroxy groups and/or amino groups of component e),
f) formic acid or formic acid and hydrocarbons as blowing agents,
are reacted together in a one-shot process in the absence of a component acting as a stopper to form an EPIC foam, and the generated foam is subsequently annealed.

In further embodiments according to the invention, the two exemplary embodiments described above are performed with water as a blowing agent.

In further embodiments according to the invention, the two exemplary embodiments described above are performed with water and formic acid as blowing agents.

In further embodiments according to the invention, the two exemplary embodiments described above are performed in the absence of a flame retardant.

In further embodiments according to the invention, the two exemplary embodiments described above are performed with acetic acid as a blowing agent.

In further preferred embodiments according to the invention, the two embodiments described above are performed in such a way that the resulting foam contains <6% by weight, more preferably <0.8% by weight, of urethane groups and/or urea groups derived from the reaction of the polyisocyanate a) with e1) multifunctional compounds containing hydroxy groups and/or amino groups, based on the total weight of the components.

The foams according to the invention have a low thermal conductivity, very good mechanical properties, such as a high compressive strength, and a high modulus of elasticity in compression. Further, the foams according to the invention are hardly flammable and generate little heat and smoke upon combustion. They have low dielectric losses, the moisture resistance and abrasion resistance as well as the processability in molds are excellent. Therefore, the foams according to the invention are excellently suitable as filling foams for hollow spaces, as filling foams for electric insulation, as a core of sandwich constructions, for the preparation of construction materials for all kinds of interior and exterior applications, for the preparation of construction materials for vehicle, ship, airplane and rocket construction, for the preparation of airplane interior and exterior construction parts, for the preparation of all kinds of insulation materials, for the preparation of insulation plates, tube and container insulations, for the preparation of sound-absorbing materials, for use in engine compartments, for the preparation of grinding wheels, and for the preparation of high-temperature insulations and hardly flammable insulations.

The invention will be further explained by means of the following Examples.

### EXAMPLES

In the following Examples, all percentages are by weight.

The measurement of the bulk densities was effected according to DIN 53 420 on foam cubes (5 cm×5 cm×5 cm) that were cut from the middle of the foams.

The measurement of the compressive strengths was effected according to DIN EN 826 on foam cubes (5 cm×5 cm×5 cm) that were cut from the middle of the foams.

The measurement of the maximum average rate of heat emission (MARHE) was effected according to ISO 5660-1. The measurement of the total smoke production per occupied surface (TSP) was effected according to ISO 5660-2. All tests were performed with a radiant heat flux density of 50 kW/m² on test specimens having dimensions of 100 mm×100 mm×20 mm.

The flammability and flame spread were determined according to the requirements of building material class B2 according to DIN 4102-1.

Isocyanate:

MDI-1: Desmodur 44 V 70 L, mixture of about 35% by weight monomeric MDI and 65% by weight polymeric MDI, f=3.19, isocyanate content 30.5 to 32%, viscosity at 20° C. is 1100 mPa·s according to DIN 53 019; commercial product of the Bayer MaterialScience AG, Leverkusen/Germany

MDI-2: mixture of about 30% by weight monomeric MDI and 70% by weight polymeric MDI, functionality of about 2.8, isocyanate content 31.5 g/100 g according to ASTM D 5199-96 A, viscosity at 25° C. is 550 mPa·s according to DIN 53 018

Epoxide:

BADGE1: Ruetapox 0162, diglycidyl ether of bisphenol A, commercial product from Bakelite AG; Duisburg/Germany, epoxide index: 5.8-6.1 eq/kg and an epoxy equivalent of 167-171 g/eq, viscosity at 25° C.: 4000-5000 mPas

BADGE2: Araldite GY250, diglycidyl ether of bisphenol A, commercial product from Huntsman, Basel/Switzerland, epoxide index: 5.3-5.45 eq/kg and an epoxy equivalent of 182-192 g/eq, viscosity at 25° C.: 10,000-12,000 mPas according to DIN/ISO 9371 B

BADGE3: Leuna Epilox® A 18-00, diglycidyl ether of bisphenol A, commercial product of LEUNA-Harze GmbH, Leuna/Germany, epoxy equivalent of 175-185 g/eq according to DIN 16 945, viscosity at 25° C. from 8000 to 10,000 mPa·s according to DIN 53 015

BFDGE: Araldite GY281, diglycidyl ether of bisphenol F, commercial product from Huntsman, Basel/Switzerland, epoxide index: 5.8-6.3 eq/kg and an epoxy equivalent of 158-172 g/eq, viscosity at 25° C.: 5000-7000 mPas

EPN: Araldit GY289, epoxyphenol of novolac, commercial product from Huntsman, Basel/Switzerland, epoxide index: 5.7-6.0 eq/kg and an epoxy equivalent of 167-175 g/eq, viscosity at 25° C. 7000-11000 mPas

Further Components:

POLYOL-1: Desmophen 3600Z, polyether polyol, OH number 56 mg KOH/g, f=2, prepared by propoxylation of 1,2-propylene glycol: commercial product from Bayer MaterialScience AG, Leverkusen/Germany

Tegostab B 8411: polyether polysiloxane, commercial product from Evonik, Essen/Germany

Tegostab B 8485: polyether polysiloxane, commercial product from Evonik, Essen/Germany

Accelerator DY 9577: boron trichloride/amine complex, thermolatent catalyst, commercial product from Huntsman, Bad Säckingen, Germany

Addocat 3144: N-[3-(dimethylamino)propyl]formamide, commercial product from Rheinchemie, Mannheim/Germany

FA: formic acid (98-100%), CAS No. 64-18-6, obtainable from KMF Laborchemie, Lohmar/Germany

Amasil 85%, 85% by weight formic acid in water

Disflamol DPK: diphenyl cresyl phosphate, commercial product from Lanxess, Köln/Germany

Solkane 365/227: liquid hydrofluorocarbon as a blowing agent for foams, obtainable from Solvay Fluor GmbH, Hannover, Germany

N,N-Dimethylbenzylamine, 98% CAS No. 103-83-3, obtainable from Sigma-Aldrich/Germany

N,N-Methyldibenzylamine, CAS No. 102-05-06, obtainable from Sigma-Aldrich/Germany

DETDA 80, diethyltoluenediamine, CAS No. 68479-98-1, obtainable from Lonza, Basel/Switzerland

DABCO T: (2-(2-dimethylamino)ethyl)methylamino)ethanol), commercial product of the Air Products and Chemicals, Inc.

p-Toluenesulfonic acid methyl ester: CAS No. 80-48-8, obtainable from Merck KGaA Darmstadt/Germany

Exolit RP6520: thixotropic dispersion containing red phosphorus, flame retardant from the company Clariant SE/Germany

Additive mixture 1 (AM-1): Mixture of POLYOL-1, Tegostab B 8411, N-[3-(dimethylamino)propyl]formamide, as used in Examples 1 to 11

Additive mixture 2 (AM-2): Mixture of Tegostab B 8485, diethyltoluenediamine, accelerator DY 9577, N,N-dimethylbenzylamine, and N,N-methyldibenzylamine, as used in Examples 12 and 13

### Example 1

320 g of MDI-1 was admixed with 80 g of BADGE and loaded with air using a quick stirrer for 2 minutes. With further stirring, 15.0 g of POLYOL-1, 6.0 g of Tegostab B 8411 and 3.0 g of N-[3-(dimethylamino)propyl]formamide were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box. The foam was annealed at 200° C. for 3 hours.

Bulk density: 40 kg/m³

### Example 2

320 g of MDI-1 was admixed with 80 g of BFDGE and loaded with air using a quick stirrer for 2 minutes. With further stirring, 15.0 g of POLYOL-1, 6.0 g of Tegostab B 8411 and 3.0 g of N-[3-(dimethylamino)propyl]formamide were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box. The foam was annealed at 200° C. for 3 hours.

Bulk density: 42 kg/m³

### Example 3

320 g of MDI-1 was admixed with 80 g of BADGE and 93.6 g of Disflamoll DPK and loaded with air using a quick stirrer for 2 minutes. With further stirring, 15.0 g of POLYOL-1, 6.0 g of Tegostab B 8411 and 3.0 g of N-[3-(dimethylamino)propyl]formamide were added. Immediately thereafter, 10 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box.

Bulk density: 42 kg/m³

### Example 4

320 g of MDI-1 was admixed with 80 g of BADGE and 93.6 g of Disflamoll DPK and loaded with air using a quick stirrer for 2 minutes. With further stirring, 15.0 g of POLYOL-1, 6.0 g of Tegostab B 8411 and 3.0 g of N-[3-(dimethylamino)propyl]formamide were added. Immediately thereafter, 8.8 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box. The foam was annealed at 200° C. for 3 hours.

Bulk density: 42 kg/m³

### Example 5

320 g of MDI-1 was admixed with 80 g of BADGE and loaded with air using a quick stirrer for 2 minutes. With further stirring, 15.0 g of POLYOL-1, 6.0 g of Tegostab B 8411 and 3.0 g of N-[3-(dimethylamino)propyl]formamide were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box. The reaction mixture was allowed to foam in said cardboard cup.

Bulk density: 43 kg/m³

### Example 6

320 g of MDI-1 was admixed with 80 g of BADGE and loaded with air using a quick stirrer for 2 minutes. The reaction mixture is cooled down to 10° C. in a refrigerator. With stirring, 15.0 g of POLYOL-1, 6.0 g of Tegostab B 8411 and 3.0 g of N-[3-(dimethylamino)propyl]formamide were added. Immediately thereafter, 6.0 g of formic acid (98-100%) and 19.6 g of Solkane 365/227 87/13 were added, and the reaction mixture was thoroughly mixed for another 10 s. The reaction mixture was cast into a cardboard box of 20 cm×20 cm×24 cm, and the reaction mixture was allowed to foam in said cardboard box. The foam was annealed at 200° C. for 3 hours.

Bulk density: 35 kg/m³

### Example 7

320 g of MDI-1 was admixed with 80 g of BADGE and loaded with air using a quick stirrer for 2 minutes. The reaction mixture is cooled down to 10° C. in a refrigerator. With stirring, 15.0 g of POLYOL-1, 6.0 g of Tegostab B 8411 and 3.0 g of N-[3-(dimethylamino)propyl]formamide were added. Immediately thereafter, 6.0 g of formic acid (98-100%) and 18.0 g of HFC-245fa were added, and the reaction mixture was thoroughly mixed for another 10 s. The reaction mixture was cast into a cardboard box of 20 cm×20 cm×24 cm, and the reaction mixture was allowed to foam in said cardboard box. The reaction mixture was allowed to foam in said cardboard cup. The foam was annealed at 200° C. for 3 hours.

Bulk density: 35 kg/m³

### Example 8* (Comparison, Preparation of EPIC Reaction Resin, Pretrimerization to Intermediate)

At 50° C., 800 g of a mixture of 60% 2,4′-diisocyanatodiphenylmethane and 40% 4,4′-diisocyanatodiphenylmethane (NCO content=33.6%) was mixed with 200 g of BADGE1 and 0.1 ml of N,N-dimethylbenzylamine, and subsequently heated to 120° C. The slightly exothermic reaction indicated the immediate start of the isocyanurate formation. After a reaction time of 2 hours without external heating, the charge was cooled. This resulted in an interior temperature of about 90° C. A sample was taken from the charge. The sample has an NCO content of 23%. The reaction was quenched by adding 4.28 g of p-toluenesulfonic acid methyl ester. Subsequently, the charge was stirred at 120° C. for another 30 min. A clear yellow storage-stable resin that is liquid at 20° C. and has a viscosity at 25° C. of 2080 mPa·s and an NCO content of 21.4% (B state) was formed.

### Example 9a* (Comparison with Annealing)

400 g of the resin from Example 8 was loaded with air using a quick stirrer for 2 minutes. With stirring, 17.6 g of POLYOL-1, 7.0 g of Tegostab B 8411 and 3.5 g of N-[3-(dimethylamino)propyl]formamide were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box. The foam was annealed at 200° C. for 3 hours.

Bulk density: 39 kg/m³

### Example 9b* (Comparison without Annealing)

400 g of the resin from Example 8 was loaded with air using a quick stirrer for 2 minutes. With stirring, 17.6 g of POLYOL-1, 7.0 g of Tegostab B 8411 and 3.5 g of N-[3-(dimethylamino)propyl]formamide were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box.

Bulk density: 39 kg/m³

### Example 10

320 g of MDI-1 was admixed with 80 g of BFDGE and loaded with air using a quick stirrer for 2 minutes. With further stirring, 15.0 g of POLYOL-1, 6.0 g of Tegostab B 8411, 3.0 g of N-[3-(dimethylamino)propyl]formamide and 4 g of Exolit RP6520 were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box.

Bulk density: 42 kg/m³

### Example 11

320 g of MDI-1 was admixed with 80 g of EPN and loaded with air using a quick stirrer for 2 minutes. With further stirring, 15.0 g of POLYOL-1, 6.0 g of Tegostab B 8411 and 3.0 g of N-[3-(dimethylamino)propyl]formamide were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box.

Bulk density: 42 kg/m³

### Example 12

320 g of Desmodur 44 V 70 L was admixed with 80 g of BADGE and loaded with air using a quick stirrer for 2 minutes. With further stirring, 6.3 g of Tegostab B 8485, 4.4 g of diethyltoluenediamine, 3.3 g of accelerator DY 9577, 2.4 g of N,N-dimethylbenzylamine and 1.6 g of N,N-methyldibenzylamine were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box.

Bulk density: 40 kg/m³

### Example 13

320 g of MDI-1 was admixed with 80 g of BADGE and loaded with air using a quick stirrer for 2 minutes. With further stirring, 6.3 g of Tegostab B 8485, 4.4 g of diethyltoluenediamine, 3.3 g of accelerator DY 9577, 2.4 g of N,N-dimethylbenzylamine, 1.6 g of N,N-methyldibenzylamine and 16.0 g of Exolit RP6520 were added. Immediately thereafter, 6.0 g of formic acid (98-100%) was added, and the reaction mixture was thoroughly mixed for another 10 s. The reaction mixture was cast into a cardboard box of 20 cm×20 cm×24 cm, and the reaction mixture was allowed to foam in said cardboard box. The foam was annealed at 200° C. for 3 hours.

Bulk density: 42 kg/m³

### Example 14

340.75 g of MDI-2 and 113.1 g of BADGE3 were mixed together using a quick stirrer at 1000 rpm for 20 s to 30 s. 6.8 g of 1.36 w/w water was added and mixed at 1000 rpm for 10 s. Immediately thereafter, the additive package consisting of 12.35 g of Tegostab B 8485, 8.6 g of diethyltoluenediamine, 6.5 g of accelerator DY 9577, 4.7 g of N,N-dimethylbenzylamine and 3.1 g of N,N-methyldibenzylamine (corresponding to AM-2) and 0.81 g of Dabco T was added and mixed at 2000 rpm for 3 s. The reaction mixture was subsequently allowed to foam.

Bulk density: 28.1 kg/m³

### Example 15

340.75 g of MDI-2 and 112.5 g of BADGE3 were mixed together using a quick stirrer at 1000 rpm for 20 s to 30 s. Amasil 85% was added and mixed at 1000 rpm for 10 s. Immediately thereafter, the additive package consisting of 12.3 g of Tegostab B 8485, 7.4 g of diethyltoluenediamine, 5.6 g of accelerator DY 9577, 4.1 g of N,N-dimethylbenzylamine and 2.7 g of N,N-methyldibenzylamine (corresponding to AM-2) and 0.81 g of Dabco T was added and mixed at 2000 rpm for 3 s. The reaction mixture was subsequently allowed to foam.

Bulk density: 36.4 kg/m³

TABLE 1

| | 1 | 2 | 3 | 4 | 5 | 10 | 11 | 6 | 7 | 9a* | 9b* |
|---|---|---|---|---|---|---|---|---|---|---|---|
| Epoxy component | BADGE2 | BFDGE | BADGE2 | BADGE2 | BADGE2 | BFDGE | EPN | BADGE2 | BADGE2 | BADGE1 | BADGE1 |
| Blowing agent | FA | FA | FA | FA | FA | FA | FA | Solkane | HFC-245fa | FA | FA |
| | | | | | | | | 365/227 | and FA | | |
| | | | | | | | | and FA | | | |
| Flame retardant | — | — | DPK | DPK | — | Exolit | — | — | — | — | — |
| | | | | | | RP6520 | | | | | |
| Additive mixture | AM-1 | AM-1 | AM-1 | AM-1 | AM-1 | AM-1 | AM-1 | AM-1 | AM-1 | AM-1 | AM-1 |
| Annealing for 3 | yes | yes | no | yes | no | yes | yes | yes | yes | yes | no |
| hours at 200° C. | | | | | | | | | | | |
| (yes/no) | | | | | | | | | | | |
| NCO index | 452 | 427 | 387 | 416 | 453 | 444 | 314 | 451 | 451 | 453 | 453 |
| Functionality of | 3.19 | 3.19 | 3.19 | 3.19 | 3.19 | 3.19 | 3.19 | 3.19 | 3.19 | 2 | 2 |
| the MDI | | | | | | | | | | | |
| employed | | | | | | | | | | | |
| Density [kg/m³] | 40 | 42 | 42 | 42 | 43 | 42 | 42 | 35 | 35 | 39 | 39 |
| B2 small burner | passed | passed | passed | passed | passed | passed | passed | passed | passed | passed | failed |
| test (DIN 4102-1 | | | | | | | | | | | |
| B2) | | | | | | | | | | | |
| MARHE | 84.3 | 81.8 | 76.5 | 62.1 | 98.0 | 63.9 | 82.5 | 87.6 | 88.1 | 120.2 | 132 |
| [kW/m²] | | | | | | | | | | | |
| TSP [m²/m²] | 271.6 | 554.5 | 984.6 | 746.9 | 848.8 | 860.1 | 346.3 | 543.2 | 486.6 | 912.2 | 761 |
| Compressive | 278 | 270 | 257 | 227 | 289 | 256 | 302 | 192 | 180 | 246 | 296 |
| strength | | | | | | | | | | | |
| F 10% [kPa] | | | | | | | | | | | |

| | 12 | 13 | 14 | 15 |
|---|---|---|---|---|
| Epoxy component | BADGE2 | BADGE2 | BADGE3 | BADGE3 |
| Blowing agent | FA | FA | water | FA + water |
| Flame retardant | — | Exolit RP6520 | — | — |
| Additive mixture | AM-2 | AM-2 | AM-2 | AM-2 |
| Annealing for 3 | yes | yes | no | no |
| hours at 200° C. | | | | |
| (yes/no) | | | | |
| NCO index | 445 | 445 | | |
| Functionality of | 3.19 | 3.19 | 2.8 | 2.8 |
| the MDI | | | | |
| employed | | | | |
| Density [kg/m²] | 40 | 42 | 28.1 | 36.4 |
| B2 small burner | passed | passed | passed | passed |
| test (DIN 4102-1 | | | | |
| B2) | | | | |
| MARHE [kW/m²] | 76 | 48 | 75 | 74 |
| TSP [m²/m²] | 571.5 | 339.5 | 588.5 | 565.9 |
| Compressive | 250 | 205 | 131 | 198 |
| strength | | | | |
| F 10% [kPa] | | | | |

Examples 1 and 2 according to the invention both have excellent mechanical properties with compressive strengths of from 270 to 280 kPa at densities around 40 kg/m³. In a Cone Calorimeter Test, very low MARHE and TSP (total smoke production) values were achieved, which demonstrate the excellent flame-retardant properties of the foams. With a MARHE value of 84.3 kW/m², Example 1 also has a very low TSP of 2.4 m². A similar case is seen in Example 2 with a MARHE value of 81.8 kW/m² and a TSP of 4.9 m².

In each of Examples 3 and 4 according to the invention, DPKs were added as flame retardants. In contrast to the foam from Example 4, the resulting foam of Example 3 was not annealed. For the same bulk density, both foams showed excellent Cone Calorimeter Test results. The MARHE values with 76.5 kW/m² (Example 3, not annealed) and 62.1 kW/m² (Example 4, annealed) are very low, the flue gas density with 8.7 m² (Example 3) and 6.6 m² (Example 4) being in the expected range. As can be seen from the Cone Calorimeter Test results, the annealing of the foams has only a little influence on the fire properties. As can be seen from Table 1, the compressive strengths are also very good.

In Example 5 according to the invention, a foam was also prepared with formic acid as the blowing agent, which was not annealed, however. In this Example 5 according to the invention, the compressive strength is also very high with 289 kPa. A very good MARHE value of 98 kW/m² is achieved even without an annealing process.

In Example 10 according to the invention, red phosphorus was added as a flame retardant. In the Cone Calorimeter Test, a very low MARHE value of 63.9 kW/m² and a TSP value of 7.6 m² were achieved, which demonstrates the excellent flame retarding properties of the foams.

In Example 11 according to the invention, EPN was employed as an epoxide component. The resulting foam has excellent mechanical properties with a compressive strength of 302 kPa. In the Cone Calorimeter Test, very low MARHE (82.5 kW/m²) and TSP (3.06 m²) values were achieved, demonstrating the excellent flame retarding properties of the foams.

In Examples 12 (without flame retardant) and 13 (with red phosphorus as the flame retardant), alternative additive mixtures were employed, which also achieved very good MARHE and TSP values.

In Examples 6 and 7 according to the invention, a mixture of Solkane 365/227 and formic acid (Example 6) and a mixture of HFC-245fa and formic acid (Example 7) were used instead of formic acid. The polymeric MDI employed had a functionality of f=3.19. The resulting foams have a good compressive strength of 192 kPa (Example 6) and 180 kPa (Example 7) with a bulk density of 35 kg/m³. The MARHE values, being 87.6 (Example 6) and 88.1 kW/m² (Example 7), are very low and comparable with those of foams that were foamed only with formic acid. The flue gas densities, being 4.8 m² (Example 6) or 4.3 m² (Example 7), are also in a comparable range.

Also, the use of water or mixtures of water/formic acid as blowing agents yield foams with better properties than those of the prior art foams.

The foam from Comparative Example 9a* and b* (formic acid as blowing agent) was prepared in a two-step process. At first, as described in Comparative Example 8, monomeric MDI was subjected to preliminary trimerization to a particular NCO value, and the thus obtained prepolymer was converted to a foam only thereafter. The functionality of the MDI employed was f=2. The foam from Comparative Example 9a* was annealed at 200° C. for 3 hours. The Cone Calorimeter results with a MARHE value of 120.2 kW/m² and a TSP of 8 m² are significantly worse than the values from the Examples according to the invention, but the small burner test was passed. In contrast, the foam from Comparative Example 9b* was not annealed, and in this case, the small burner test was failed.

1.-15. (canceled)

16. A process for preparing a high-temperature resistant foam, comprising the reaction of
a) at least one mixture of organic polyisocyanates, and
b) at least one organic compound having at least two epoxy groups
in an amount that corresponds to an equivalent ratio of isocyanate groups to epoxy groups of from 1.2:1 to 500:1,
in the presence of
c) optionally at least one catalyst accelerating the isocyanate/epoxide reaction,
e) optionally in the presence of auxiliary agents and additives,
f) chemical and/or physical blowing agents,
wherein
said polyisocyanate a) contains more than 50% by weight of polyphenyl polymethylene polyisocyanates having a functionality f>2 and the structural formula C₁₅H₁₀N₂O₂ [C₈H₅NO]ₙ, where n=integer >0, and
that the organic compound b) contains one or more polyglycidyl ethers selected from the group consisting of the polyglycidyl ethers of bisphenol A, bisphenol F and novolac,
that the chemical and/or physical blowing agents f) include at least one carboxylic acid selected from formic acid and acetic acid, or that said blowing agent consists of water and optionally one or more compounds selected from the group containing hydrocarbons, fluorocarbons, and fluorohydrocarbons, and
that the reaction proceeds in the absence of a component d) acting as a stopper.

17. The process according to claim 16, wherein said mixture of organic polyisocyanates a) contains more than 55% by weight polyphenyl polymethylene polyisocyanates with f>2 and the structural formula C₁₅H₁₀N₂O₂ [C₈H₅NO]ₙ, where n=integer >0.

18. The process according to claim 16, wherein the organic compound b) contains a polyglycidyl ether of bisphenol F.

19. The process according to claim 16, wherein said catalyst is employed in an amount of from ≧0 to <2.0% by weight, based on the total weight of components (a) and (b).

20. The process according to claim 16, wherein said foam contains <0.8% by weight of urethane groups and/or urea groups derived from the reaction of the polyisocyanate a) with e1) multifunctional compounds containing hydroxy groups and/or amino groups, based on the total weight of the components.

21. The process according to claim 16, wherein said further auxiliary agents and additives e) are included in such a maximum amount that the ratio of the weight of all compounds containing hydroxy and/or amino groups e1) to the weight of epoxy component b) is smaller than 30:70 and preferably at most 28:72, more preferably at most 25:75, and even more preferably at most 20:80.

22. The process according to claim 16, wherein said further auxiliary agents and additives e) are included in such a maximum amount that less than 28% by weight, preferably less than 25% by weight, of component e1) is employed, based on the total weight of components b) and e1), and said EPIC foam contains ≧0.01 to ≦1% by weight, preferably ≧0.01 to <0.8% by weight, of urethane and/or urea groups derived from the reaction of polyisocyanate a) with component e), based on the total weight of the foam.

23. The process for preparing high-temperature resistant foams according to claim 16, containing the steps of
(i) mixing the components a) to f),
(ii) reacting the components a) to f) in a one-shot process.

24. The process according to claim 16, wherein, after said foaming to the foamed state, a subsequent temperature treatment is performed at from 70 to 250° C., or no temperature treatment is performed.

25. The process for preparing a foam according to claim 24, wherein an aminic compound selected from the group consisting of boron trichloride tert. amine adducts, N,N-dimethylbenzylamine, N,N-methyldibenzylamine, a compound with at least two isocyanate-reactive hydrogen atoms and a molecular weight of less than 500 g/mol, wherein at least one of said isocyanate-reactive hydrogen atoms belongs to a primary or secondary amino group, and mixtures thereof, is added.

26. A high-temperature resistant foam obtainable by a process according to claim 16.

27. A method comprising utilizing the high-temperature resistant foams according to claim 26 as a filling foam for hollow spaces, as a filling foam for electric insulation, as a core of sandwich constructions, for the preparation of construction materials for all kinds of interior and exterior applications, for the preparation of construction materials for vehicle, ship, airplane and rocket construction, for the preparation of airplane interior and exterior construction parts, for the preparation of all kinds of insulation materials, for the preparation of insulation plates, tube and container insulations, for the preparation of sound-absorbing materials, for use in engine compartments, for the preparation of grinding wheels, and for the preparation of high-temperature insulations and hardly flammable insulations.

28. A method comprising utilizing a foamable mixture before the foaming to the high-temperature resistant foam according to claim 26 is complete for adhesively bonding substrates, for adhesively bonding steel, aluminum and copper plates, plastic sheets, and polybutylene terephthalate sheets.

29. Hollow spaces, electric insulations, cores of sandwich constructions, sandwich constructions, construction materials for all kinds of interior and exterior applications, construction materials for vehicle, ship, airplane and rocket construction, airplane interior and exterior construction parts, all kinds of insulation materials, insulation plates, tube and container insulations, sound-absorbing materials, damping and insulation materials in engine compartments, grinding wheels, high-temperature insulations, and hardly flammable insulations, comprising the high-temperature resistant foams according to claim 26.

30. Bondings between substrates, e.g., steel, aluminum and copper plates, plastic sheets, e.g., polybutylene terephthalate sheets, comprising the high-temperature resistant foams according to claim 26.
